(19) United States
(12) Patent Application Publication
(10) Pub. No.: US 2002/0077895 A1
(43) Pub. Date: Jun. 20, 2002

(54) Electronic consumer incentive distribution system

(76) Inventor: Steve Howell, Tampa, FL (US)

Correspondence Address: Michael J. Colitz, Jr., 217 Harbor View Lane, Largo, FL, 33770, US

(21) Appl. No.: 09/740,158

(22) Filed: Dec. 18, 2000

(51) Int. Cl. G06F 17/60

(52) U.S. Cl. 705/14

(57) ABSTRACT

A system comprises several components for electronically distributing consumer incentives. The merchant uses a first link to inform a distributor of the incentive, then an EBD with a second link to communicate and authorize the incentive to a service provider. An ESPD communicates via the second link which communicates with the EBD and may contact a consumer by a third link and offer the authorized incentive. The ESPD provides the consumer with a unique identification number. An ECD enables the consumer to communicate by the third link with the ESPD and inquire of available incentives. A personal device contains and transmits a unique identification number to a consumer by the service provider. A plurality of ERDs each of which is located at the site of receipt of the incentive. The ERD is coupled to the ESPD by a fourth link and may communicate with the ESPD.

### BACKGROUND OF THE INVENTION

1. Field of the Invention

The present invention relates to an electronic consumer incentive distribution system and more particularly pertains to conveniently and efficiently providing information and access to consumer incentives.

2. Description of the Prior Art

The use of known means and methods of providing consumer incentives is known in the prior art. More specifically, known means and methods of providing consumer incentives previously devised and utilized for the purpose of providing consumer incentives through known methods and procedures are known to consist basically of familiar, expected, and obvious structural configurations, notwithstanding the myriad of designs encompassed by the crowded prior art which has been developed for the fulfillment of countless objectives and requirements.

By way of example, U.S. Pat. No. 6,009,411 to Kepecs issued Dec. 28, 1999 discloses a method of utilizing the internet and a “key” number to gain access to incentives with the use of the internet to credit the consumer's account for payment of goods. U.S. Pat. No. 6,014,634 to Scroggie et al issued Jan. 11, 2000, discloses an incentive system in which the consumer selects a merchant before he or she actually shops for the goods. U.S. Pat. No. 6,014,635 to Harris et al issued Jan. 11, 2000, discloses an incentive system which is coupled to a credit card system. Lastly, U.S. Pat. No. 4,833,607 to Dethloff et al issued May 23, 1989 discloses a financial apparatus to control economic system development.

While these devices fulfill their respective, particular objectives and requirements, the aforementioned patents do not describe an electronic consumer incentive distribution system that allows conveniently and efficiently providing information and access to consumer incentives.

In this respect, the electronic consumer incentive distribution system according to the present invention substantially departs from the conventional concepts and designs of the prior art, and in doing so provides an apparatus primarily developed for the purpose of conveniently and efficiently providing information and access to consumer incentives.

Therefore, it can be appreciated that there exists a continuing need for a new and improved electronic consumer incentive distribution system which can be used for conveniently and efficiently providing information and access to consumer incentives. In this regard, the present invention substantially fulfills this need.

### SUMMARY OF THE INVENTION

In view of the foregoing disadvantages inherent in the known types of known means and methods of providing consumer incentives now present in the prior art, the present invention provides an improved electronic consumer incentive distribution system. As such, the general purpose of the present invention, which will be described subsequently in greater detail, is to provide a new and improved electronic consumer incentive distribution system and method which has all the advantages of the prior art and none of the disadvantages.

To attain this, the present invention essentially comprises an electronic consumer incentive distribution system for conveniently and efficiently allowing a merchant to electronically distribute, and a consumer to electronically acquire, promotions, rebates, discounts and other incentives. The system comprises several components, in combination. First there is a plurality of electronic business devices (EBD). Each device includes a first link whereby a merchant may, optionally, communicate with a distributor and communicate a desire to provide a consumer incentive. The communication via the first link further provides the incentive beginning date and ending date as well as an authorization number for the incentive. Each merchant's EBD also utilizes a second link of the EBD to communicate with and authorize a service provider to advertise incentives which are then made available by the service provider to a consumer. Next provided is a plurality of unique consumer identification numbers, each of which is associated with an individual consumer number and, optionally, an incentive authorization number. Next provided is an electronic service provider device (ESPD). This device includes a service provider computer. The computer includes a program to assign and record a plurality of numerals which become a consumer's unique identification number. The computer is also adapted to effect communications by the second link to a business device. The ESPD can communicate with the EBD concerning an authorized incentive to be provided. The ESPD may then initiate contact via a third link with a consumer and advise a consumer of authorized incentives. A consumer is enabled by the third link to receive an incentive and select an incentive program in which the consumer desires to participate. After making a selection the ESPD approves the consumer's unique identification number to receive an incentive at a point of purchase. The ESPD is adapted to provide a fourth link to an electronic identification reception device. Each electronic identification reception device (ERD) is located at a point of purchase. The ESPD is coupled to and communicates, with the ERD. The coupling and communication between the ESPD and an ERD enables the approval of the incentive at the point of purchase. The ESPD is adapted to run a file program which lists a consumer's preferences and all of a consumer's past requests for information regarding consumer goods and specific incentives. Next provided is a plurality of electronic consumer devices (ECD). Each ECD is coupled to the ESPD by the third link. Each ECD is capable of communicating the unique consumer identification number and, optionally, the unique authorization number to and from the ESPD. The ECD is adapted to use search programs by which the ECD is coupled to and adapted to communicate with the ESPD. The use of the ECD enables the consumer to search for incentives that the consumer is interested in. The consumer may select such incentives as desired for utilization in making purchases. Next provided is a plurality of identification devices (IDD), each of which is adapted to be capable of transmitting signals. A identification device is provided to a consumer by a service provider. It is then possessed and utilized by the consumer. The identification device is adapted to contain, and made capable of transmitting, a unique identification number and, optionally, a unique authorization number. Lastly there is a plurality of electronic reception devices (ERD) each being coupled to an identification device via the fourth link to a ESPD. The ERD is located at the point of purchase of items which are subject of an incentive. The ERD is capable of receiving a signal containing a unique consumer identification number and, optionally, to an authorization number from a consumer's identification device. The ERD is also capable of communicating the number to the ESPD via the fourth link. The ERD receives authorization via the fourth link approving the incentive. The ERD is capable of authorizing an incentive at a point of purchase.

There has thus been outlined, rather broadly, the more important features of the invention in order that the detailed description thereof that follows may be better understood and in order that the present contribution to the art may be better appreciated. There are, of course, additional features of the invention that will be described hereinafter and which will form the subject matter of the claims attached.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved electronic consumer incentive distribution system which has all of the advantages of the known prior art and none of the disadvantages.

It is another object of the present invention to provide a new and improved electronic consumer incentive distribution system which may be easily and efficiently manufactured and marketed.

It is further object of the present invention to provide a new and improved electronic consumer incentive distribution system which is of durable and reliable constructions.

An even further object of the present invention is to provide a new and improved electronic consumer incentive distribution system which is susceptible of a low cost of manufacture with regard to both materials and labor, and which accordingly is then susceptible of low prices of sale to the consuming public, thereby making such electronic consumer incentive distribution system economically available to the buying public.

Even still another object of the present invention is to provide an electronic consumer incentive distribution system for conveniently and efficiently providing information and access to consumer incentives.

Lastly, it is an object of the present invention to provide a new and improved system for electronically distributing consumer incentives. A system comprises several components for electronically distributing consumer incentives. Firstly the merchant uses a first link to inform a distributor of the pending incentive. The merchant then uses a EBD with a second link to communicate and authorize the incentive to a service provider. Next there is provided an ESPD which includes a communication means via the second link adapted communicate with the EBD. The ESPD may also contact a consumer by a third link communications means and may offer the authorized incentive. The ESPD provides the consumer with a unique identification number and an authorization number. There is also provided an ECD which enables the consumer to communicate by the third link with the ESPD wherein the consumer may inquire of available incentives. Also provided is device being provided to a consumer by the service provider. The device is capable of containing and causing the transmitting of a unique identification and authorization number. Lastly, there is provided a plurality of ERDs each of which is located at the site of receipt of the incentive. The ERD is authorizing the incentive to be provided to the consumer. The ERD is coupled to the ESPD by a fourth link and may communicate with the ESPD.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is schematic of the system.

FIG. 2 is a flow diagram of the system.

The same reference numerals refer to the same parts throughout the various Figures.

### DESCRIPTION OF THE PREFERRED EMBODIMENT

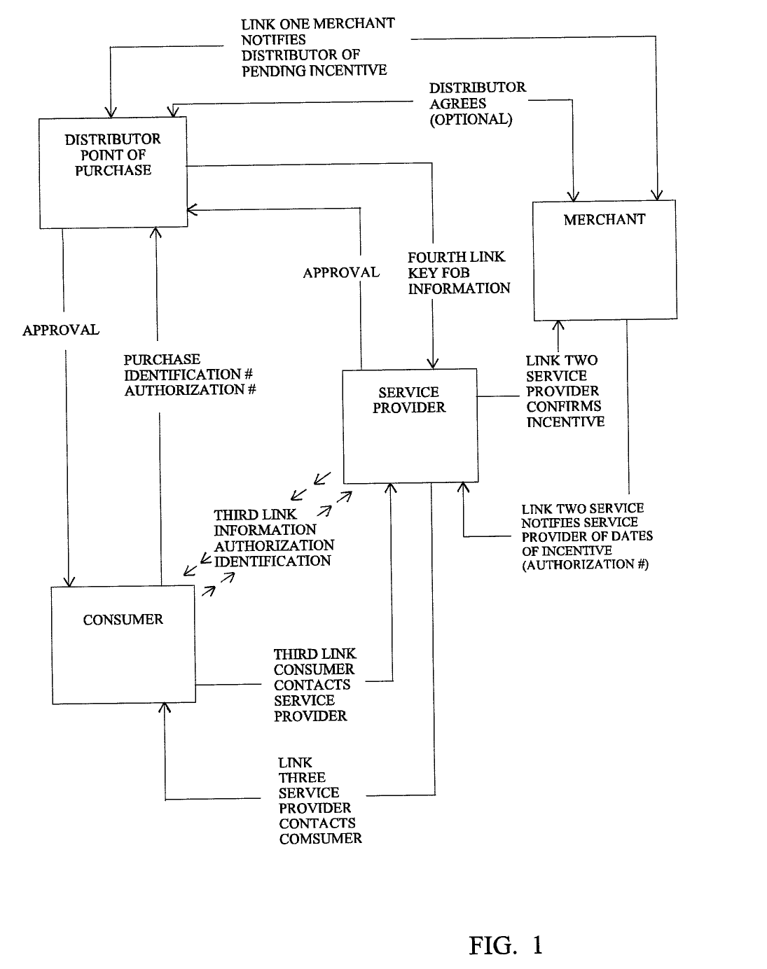

With reference now to the drawings, and in particular to FIG. 1 thereof, the preferred embodiment of the new and improved electronic consumer incentive distribution system embodying the principles and concepts of the present invention will be described.

The present invention, the electronic consumer incentive distribution system is comprised of a plurality of components. Such components in their broadest context include a plurality of merchant's electronic devices, an electronic service provider device, a plurality of electronic consumer devices, a plurality of identification devices and a plurality of point of purchase electronic reception devices. Such components are individually configured and correlated with respect to each other so as to attain the desired objective.

An electronic consumer incentive distribution system for allowing a merchant to electronically distribute, and a consumer to electronically acquire, promotions, rebates, discounts and other incentives utilizing a computer and electronic connections. The system conveniently and efficiently provides information about and access to such incentives. The system comprises, in combination several components.

First there is a plurality of electronic business devices (EBD). In the preferred embodiment this device may comprise a personal computer, as well as a telephone and fax machine. This device includes a first link whereby a merchant may contact a distributor and communicate the merchant's desire to provide consumer incentives. This communication sets forth the initiation and termination dates of the incentive as well as the authorization number for the incentive. Utilizing a second link of the EBD, the merchant may contact a service provider and communicate the merchant's desire to provide a consumer incentive. Such second link may, in most instances, be used instead of the first link.

The merchant utilizes the second link of the EBD to authorize the service provider to advertise incentives. In the preferred embodiment, the merchant would advise the service provider that the merchant had notified the distributors of its product of the upcoming incentive, providing initiation and termination dates of the incentive as well as an authorization number of the incentive. The incentives are then made available by the service provider to a consumer. In the preferred embodiment the communication of the incentive from the merchant to the distributor may be in the form of a written notice.

Next provided is a plurality of unique consumer identification numbers associated with an individual consumer and incentive authorization numbers. In the preferred embodiment the number may be one generated by the merchant. The identification number may be a number assigned to the consumer by the service provider. The identification number may also be a consumer credit card number.

Next provided is an electronic service provider device (ESPD). This device includes a service provider computer. In the preferred embodiment the ESPD may also include a telephone and a fax machine. The service provider computer includes a program to assign and record a plurality of numerals which become a consumer's unique identification number. The computer is also adapted to effect communications by the second link to a EBD. The ESPD can communicate with a EBD concerning an authorized incentive to be provided. The ESPD may then initiate contact via a third link with a consumer and advise a consumer of authorized incentives. A consumer is enabled by the third link to receive an incentive and select an incentive program in which the consumer desires to participate. In the preferred embodiment the third link may be provided by a personal computer as well as a fax machine, telephone and hand held communication device such as a cell phone, palm pilot and the like. Communication of the incentive may take the form of a downloadable and printable computer printout including the requisite identification and authorization numbers for verification of incentive. The authorization number is an optional aspect of the invention.

After the consumer selects an incentive, the ESPD approves the consumer's unique identification number to receive an incentive at a point of purchase. The ESPD is adapted to provide a fourth link to a personal device, preferably a personal identification device (IDD) such as a credit card with a magnetic strip or a bar code or a key fob for an electronic reception device (ERD). An ERD is located at a point of purchase. The ESPD is coupled to and communicates, with the ERD. The coupling and communication between the ESPD and the ERD enables the approval of the incentive at the point of purchase.

The ESPD is adapted to run a file program which lists a consumer's preferences and all of a consumer's past requests for information regarding consumer goods and specific incentives.

Next provided is a plurality of electronic consumer devices (ECD). Each ECD is coupled to the ESPD by the third link. The ECD is capable of communicating the unique consumer identification number and the unique authorization number to and from the ESPD. The ECD is adapted to use search programs by which the ECD is coupled to and adapted to communicate with the ESPD. The use of the ECD enables the consumer to search for incentives that the consumer is interested in. The consumer may select such incentives as desired for utilization in making purchases.

Next provided is a plurality of personal identification devices, each of which is adapted to be capable of transmitting signal waves. The identification device is provided to a consumer by a service provider. It is then possessed and utilized by the consumer. The identification device is adapted to contain, and made capable of transmitting, a unique identification number and, optionally, a unique authorization number.

Lastly there is a plurality of electronic reception devices (ERD) being coupled to an identification device and via the fourth link to an ESPD. The ERD is located at the point of purchase of items which are subject of an incentive. The device is capable of receiving a signal containing a unique consumer identification number and, optionally, a unique authorization number from a consumer's identification device. The ERD is also capable of communicating the number to the ESPD device via the fourth link.

The ERD receives authorization via the fourth link approving the incentive. The ERD is capable of communicating the number to the ESPD. The ERD is capable of receiving authorization via the fourth link approving the incentive. The ERD is capable of authorizing an incentive at a point of purchase. In the preferred embodiment of the system, the ERD may also be a telephone and fax machine. In the preferred embodiment of the invention, the system may include a printout of a computer generated authorization commonly known as a coupon. The coupon would be tendered in lieu of utilization of the identification device and electronic reception device for securing a consumer incentive.

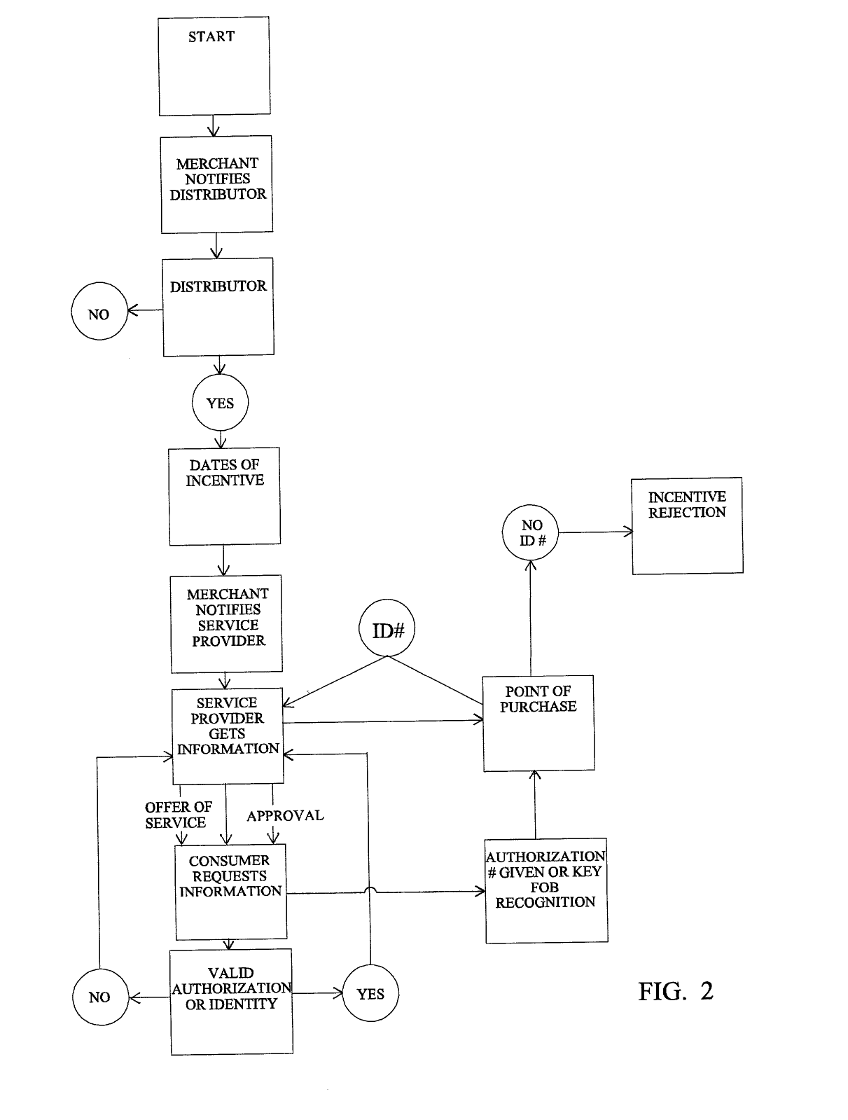

By way of FIG. 2, the flow diagram, the utilization and employment of the system may be demonstrated by the diagram and as follows. The merchant notifies all the distributors of its product that the merchant intends to offer a purchase incentive. As is the case currently in the market place, the merchant informs the distributor of the initiation date, the termination date, and the terms of the incentive. The merchant then contacts the service provider. There is an exchange of information between the two entities regarding the dates and amount of the incentive. The merchant may wish to roll the incentive into another existing incentive. When the details are fixed, the service provider lists the incentive in the data bank. The service provider offers a menu of services to the consumer, with each consumer having a unique identification number. One such service may be a service by which the service provider notifies the consumer of new incentives based on the consumer's stated interests. The consumer may also only subscribe to a service which allows the consumer to search for incentives. When the consumer locates the incentive he is interested in or is notified of such an incentive, the consumer may select that incentive. At that point his data file lists that incentive, and his identification number is authorized for that incentive. When the consumer makes the purchase, which is subject to the incentive, he either produces his identification card or activates communication to the service provider computer via the identification device. The receipt of the key fob signal initiates a communication link between the reception device and the service provider computer. If the consumer produces his identification device with unique number, the distributor may use a reader such as a “swipe” machine, commonly used with credit cards or a bar code scanner, to communicate with the service provider and receive authorization for the incentive.

The present invention also includes the method for electronic consumer incentive distribution, comprising, the following steps: providing an EBD coupled by a first link to a service provider whereby a merchant may communicate a desire to provide a consumer incentive to the ESPD and may authorize the service provider to provide a consumer incentive; providing a unique consumer identification and authorization number; providing an ESPD including a communication means having a second link adapted to receive communications and information from a merchant through a merchant's EBD concerning incentives to be provided and the ESPD may initiate contact with a consumer by a communications means which includes a third link and advise a consumer of authorized incentives, the communication means also providing the consumer with a unique identification number; providing an ECD coupled to a ESPD by the third link by which a consumer is enabled to communicate with the ESPD and may inquire of incentives; providing a personal device being provided to a consumer by the service provider and the device being capable of containing and allowing the transmitting of a unique identification and authorization number; providing an ERD being coupled to the ESPD by a fourth link, the ERD being located at a site where a consumer purchases goods which are subject of an incentive, and the ERD is capable of receiving a unique consumer identification number and authorization number, and communicating the number to the ESPD for approval, and receiving approval via the fourth link, and approving the consumer incentive at the point of purchase; and distributing consumer incentives electronically with such equipment.

In summary, the system and process of the operation of the system would be used to facilitate a merchant's creation, distribution as well as the customer's selection and redemption of electronic coupons, rebates, and incentives.

The system comprises computers, televisions, telephones, pagers, palm pilots or other similar hand held communication devices, with a display screen which can be used to access a computer network. The system may utilize a credit card type consumer identification card which is encoded with the consumer's unique identification in both bar-code and/or magnetic strip format, as well as an electronic radio frequency “key-fob” device.

The system comprises the steps of a merchant creating and distributing the notice of the pending incentive to the distributors of its product. After the distributors of goods are notified, the merchant notifies the service provider of the pending incentive. The service provider authenticates the merchant's incentive before proceeding to enter the incentive information into the service provider's data bank. The service provider may give the merchant an option to create a new incentive, or modify an existing incentive. Available data fields include a summary of the incentive, the text of the incentive, a graphic, the initiation and expiration dates, and the chosen means of distribution for the incentive. The summary text will be converted into a short word advertisement (i.e. 30% Off All Music) which, when selected by the consumer, will hyperlink to the full details of the ad. The chosen means of distribution can include world-wide-web, e-mail, or any other service offered on the Internet. The distribution will be handled by the service provider according to predefined agreements between the merchant and the service provider. The process also includes the necessary steps of the consumer for the selection of incentives that the consumer might wish to utilize and for the steps necessary for the consumer to redeem an incentive. The consumer will receive the hyperlink to an incentive by way of the display of the incentives summary text (i.e. 30% Off All Music) on an electronic device. Upon the selection of the summary text ad, the entire incentive details will be displayed. The consumer then has the option to either mark the incentive as “interested in” or “not interested in” this incentive. If the consumer marks themselves as being interested in that incentive then the service provider will create a link in a database from the consumer identification to the selected incentive. To redeem the incentive the consumer will proceed to the issuing merchant and authenticate their identification to the merchant through the use of the prior encoded consumer identification device card or key-fob device. The card can be verified by swiping it through a mag-stripe reader or by scanning its bar-code with a bar-code reader. The key-fob device can be verified by holding it in proximity to a sensor device. The merchants' electronic reception device will be connected remotely to the service provider system and will query the service provider database for the necessary link between the consumer identification and the appropriate incentive thereby authorizing the discount for the consumer.

A single method of one of the many methods by which this system may be employed is demonstrated as follows.

A person uses their personal computer and internet connection to access the web-site of a service provider which they are a member of by way of prior sign-up and agreement with the service. Upon signing up for the service the person indicated that they were interested in receiving any advertisements for music, food, shoes, or any advertisements from specific merchants such as “Joe's Ice-Cream” or “The Pub”.

Upon entering their user name to the web-site the person is presented with a web-page that has been customized to display subjects that were of interest to that person. Included on the page are text-based advertisements saying “30% Off All Music” and “½ Cover”. Upon clicking on these ads the person is presented with the details of the coupon explaining the participating merchant and the expiration dates/times. The person is interested in both incentives so they mark them both “interested in”. At that point the service system knows that this person has “opted in” to possibly using these two coupons.

The person goes to the music store that offered the 30% off coupon and takes their selections to the check-out counter to pay. They tell the cashier that they have a coupon and proceed to swipe their member card through a card reader, the electronic reception device. The members unique identification, which is all that is kept on the card, is transmitted to the service provider's computer, and that system responds to the reception device that the person is eligible to receive 30% off.

The person goes to “The Pub” and is met at the door by the employee collecting the cover charge to get into the bar. The person presents his member card and the bar-code on the card is scanned by a wireless handheld bar-code scanner. The information read from the bar-code, again only the member's unique identification number, is sent from The Pub to query the service database, and the signal returns the authorization number to collect only one-half of the cover charge.

As to the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed as being new and desired to be protected by letters patent of the united states is as follows:

1. An electronic consumer incentive distribution system for allowing a merchant to electronically distribute, and a consumer to electronically acquire, promotions, rebates, discounts and other incentives utilizing a computer and electronic connections for conveniently and efficiently providing information about and access to such incentives, comprising, in combination;
a plurality of an electronic business device (EBD) each of which includes an optional first link whereby a merchant may communicate with a distributor and communicate a desire to provide a consumer incentive, the communication further providing the incentive beginning date and ending date as well as an authorization number for the incentive, and the merchant business device also utilizing a second link of the business device to communicate with and authorize a service provider to advertise incentives which are then made available by the service provider to a consumer;
a plurality of a unique consumer identification numbers (CIN) and incentive authorization numbers (IAN) each of which is associated with an individual consumer;
an electronic service provider device (ESPD) including a service provider computer which further includes a program to assign and record a plurality of numerals which become the consumer unique identification number and the computer is adapted to effect communications by the second link to a business device, and exchange information received from the business device concerning an authorized incentive to be provided, and whereby a service provider device may initiate contact via a third link with a consumer and advise a consumer of authorized incentives, and a consumer is enabled by the third link to receive an incentive and select an incentive program in which a consumer desires to participate, and in making a selection the service provider device approves a consumer's unique identification number to receive an incentive at a point of purchase, the service provider device also adapted to provide a fourth link to an identification reception device being located at a point of purchase, with the service provider device being coupled to and communicating with the identification reception device and the coupling and communication between the service provider device and the identification reception device enabling the approval of the incentive at the point of purchase, and the service provider device is adapted to run a file program which lists a consumer's preferences and all of a consumer's past requests for information regarding consumer goods and specific incentives;
a plurality of an electronic consumer device (ECD) each of which is being coupled to the electronic service provider device by the third link, the consumer device being capable of communicating the unique consumer identification number and the unique authorization number to and from the service provider device, and the electronic consumer device being adapted to use search programs by which the electronic consumer device is coupled to and adapted to communicate with the electronic service provider device, and by using the electronic consumer device a consumer may search for incentives that the consumer is interested in and the consumer may select such incentives as desired for utilization in making purchases;
a plurality of identification devices (IDD), each of which is adapted to be capable of transmitting signals, the identification device being provided to a consumer by a service provider and the identification device is then possessed and utilized by the consumer, with the identification device adapted to contain, and being capable of transmitting, a unique identification number and, optionally, a unique authorization number;
a plurality of electronic reception devices (ERD) each of which is being coupled to an identification device and via the fourth link to a service provider device, and being located at the point of purchase of items which are subject of an incentive, the devices being capable of receiving a signal containing a unique consumer identification number and, optionally, an authorization number from a consumer's identification device and being capable of communicating the number to the service provider device and the reception device receiving authorization via the fourth link approving the incentive, and the electronic reception device is capable of authorizing an incentive at a point of purchase.

2. A electronic consumer incentive distribution system, comprising;
an EBD coupled by a first link to a service provider whereby a merchant may communicate a desire to provide a consumer incentive to the ESPD and may authorize the service provider to provide a consumer incentive;
a unique consumer identification number;
an ESPD including a communication means having a second link adapted to receive communications and information from a merchant through a merchant's EBD concerning incentives to be provided and may initiate contact with a consumer by a communications means which includes a third link and advise a consumer of authorized incentives, the communication means also providing the consumer with a unique identification number;
an ECD coupled to a ESPD by the third link by which a consumer is enabled to communicate with the ESPD and may inquire of incentives;
a personal device being provided to a consumer by the service provider and the device being capable of containing and allowing the transmitting of a unique number; and
an ERD being coupled to the ESPD by a fourth link, the ERD being located at a site where a consumer purchases goods which are subject of an incentive, and the ERD is capable of receiving a unique consumer identification number, and communicating the number to the ESPD for approval, and receiving approval via the fourth link, and approving the consumer incentive at the point of purchase.

3. A system as described in claim 2 wherein the EBD includes a computer being electronically connected to the internet with a data base and filing capability for storage and processing of data regarding incentives and the computer being further capable of transmitting data and information concerning incentive to other internet connected computers.

4. A system as described in claim 2 wherein the ESPD includes a computer which is electronically connected to the internet with a data base and filing capability for the storage and processing of data regarding the consumer's previous inquiries regarding specific incentives and including a system for retrieval of information and data for targeting incentives to a specific consumer, with the computer being also capable of processing and assigning a unique consumer identification and an authorization number to a consumer and transmitting the same to the consumer.

5. A system as described in claim 2 wherein the personal device being provided by the service provider and carried by the consumer is a key fob device, capable of transmitting a unique identification number by radio waves.

6. A system as described in claim 2 wherein the device being provided by the service provider and carried by the consumer is an identification card which bears a magnetic strip capable of causing the identification number to be transmitted.

7. A system as described in claim 2 wherein the unique consumer identification and authorization number may be contained within a key fob device and transmittable from a key fob device.

8. A system as described in claim 2 wherein the unique consumer identification and authorization number may be a consumer credit card.

9. A system as described in claim 2 wherein the ERD includes devices capable of receiving transmitted electronic codes from a key fob device and the reception of the authorization signal from a key fob device authorizes that an incentive be provided to a consumer and the ERD is linked via the internet to the ESPD.

10. A system as described in claim 2 wherein the EBD includes a telephone and a fax machine.

11. A system as described in claim 2 wherein the ESPD includes a telephone and a fax machine.

12. A system as described in claim 2 wherein the ESPD by which the service provider makes contact with the consumer includes use of a pager system.

13. A system as described in claim 2 wherein the ESPD by which a service provider makes contact with the consumer includes a cellular telephone.

14. A system as described in claim 2 wherein the unique consumer identification number includes a credit card number.

15. A system as described in claim 2 wherein the ECD includes a telephone and a fax machine.

16. A method for electronic consumer incentive distribution, comprising;
providing an EBD coupled by a first link to a service provider whereby a merchant may communicate a desire to provide a consumer incentive to the ESPD and may authorize the service provider to provide a consumer incentive;
providing a unique consumer identification and authorization number;
providing an ESPD including a communication means having a second link adapted to receive communications and information from a merchant through a merchant's EBD concerning incentives to be provided and the ESPD may initiate contact with a consumer by a communications means which includes a third link and advise a consumer of authorized incentives, the communication means also providing the consumer with a unique identification number;
providing an ECD coupled to a ESPD by the third link by which a consumer is enabled to communicate with the ESPD and may inquire of incentives;
providing a personal device being provided to a consumer by the service provider and the device being capable of containing and allowing the transmitting of a unique identification and authorization number;
providing an ERD being coupled to the ESPD by a fourth link, the ERD being located at a site where a consumer purchases goods which are subject of an incentive, and the ERD is capable of receiving a unique consumer identification number and authorization number, and communicating the number to the ESPD for approval, and receiving approval via the fourth link, and approving the consumer incentive at the point of purchase; and.
distributing consumer incentives electronically with such equipment.
